(19) United States
(12) Patent Application Publication
(10) Pub. No.: US 2021/0175618 A1
(43) Pub. Date: Jun. 10, 2021

(54) Transponder Device and Transponder System with Transponder Device

(71) Applicant: Smartrac Specialty GmbH, Reichsof-Wehnrath (DE)

(72) Inventors: Frederic MEYER, Erndtebrueck (DE); Christoph OHM, Siegen (DE); Ulrich Friedrich, Ellhofen (DE)

(21) Appl. No.: 17/117,341

(22) Filed: Dec. 10, 2020

(30) Foreign Application Priority Data
Dec. 10, 2019 (DE) 19401052.6

(51) Int. Cl. H01Q 1/52; H04B 1/59; H01Q 1/22

(52) U.S. Cl. CPC H01Q 1/528; H01Q 1/2208; H04B 1/59

(57) ABSTRACT

The invention relates to a transponder device (25, 35, 44, 50, 60, 80) with an antenna arrangement (14, 38, 45, 52, 65, 82) arranged on an antenna carrier (19, 36), which is in particular designed as a film antenna, wherein the transponder device has a mounting substrate (11) used to fasten on a metallic support surface. The antenna arrangement has at least one inner antenna area (16, 43, 46, 66) arranged between the mounting substrate and the antenna carrier and outer antenna area (15, 40, 51, 64, 81) arranged on the antenna carrier opposite to the inner antenna area (15, 40, 51, 64, 81), wherein at least the outer antenna area is arranged at an angle α1 relative to the mounting substrate. Furthermore, the invention relates to a transponder system with such a transponder device.

### CROSS-REFERENCE TO RELATED APPLICATION

The present application claims priority to EP Patent Application No. 19401052.6 filed Dec. 10, 2019, which is incorporated herein by reference in its entirety.

### FIELD OF THE INVENTION

The invention relates to a transponder device with an antenna arrangement arranged on an antenna carrier, which is in particular formed as a film antenna, wherein the transponder device has a mounting substrate for fastening on a metallic support surface. The antenna arrangement has at least one inner antenna area arranged between the mounting substrate and the antenna carrier and an outer antenna area arranged on the antenna carrier opposite to the inner antenna area. Furthermore, the invention relates to a transponder system with such a transponder device.

### BACKGROUND OF THE INVENTION

A transponder device with an antenna carrier for arranging a transponder is known from WO 2018/193309 A1, wherein the transponder device has an antenna arrangement which can be arranged around the antenna carrier. The antenna carrier is arranged in a housing, whose underside is formed by a mounting substrate for fastening the transponder device on the beverage steel barrel, which is used for transporting and storing beer. This kind of steel barrel, which is also called keg in terminology, is characterized by a special structure, so that a steel bladder, which is used to receive the liquid volume, both on the topside and on the underside, which are each formed as a curved bottom, has a circumferential steel barrel collar, which forms a stacking edge respectively and furthermore protects a valve centrally arranged on the topside of the bladder against mechanical damage from external influences.

Kegs are used in logistics circulation, wherein the barrels filled by several fillers are returned to the individual filler in circulation after they are emptied in an unsorted way, so that, for the respective filler, the empty kegs have to be assigned and redeliver to the external fillers. For this purpose, a reliable identification of the barrel is first of all necessary, which in particular takes into account the fact that the empty barrel regularly comes into a close spatial association with the respective filler, so that in practice it is proved that reading out the transponder data required for identification is difficult, wherein the transponder data is stored in a RFID transponder arranged at the barrel.

This problem is exacerbated by the fact that, due to the metallic design of the barrels, there is interference in the electromagnetic field required to read out the transponder data, which in existing practice has led to the RFID transponder, which is arranged at a steel barrel, being arranged as central as possible on the curved bottom of the bladder, so that in particular influences caused by the electromagnetic field can be largely excluded by the barrel collar surrounding the curved bottom.

Furthermore, the disadvantage of this exposed arrangement of the RFID transponders on the bladder has been proved that the transponders are often damaged, which leads to a failure.

Although the barrel collar obviously provides a better protection for the RFID transponder than the exposed arrangement on the bottom of the bladder, the arrangement of the RFID transponder on the inside of the barrel collar of the keg is not widespread in practice so far, because in this arrangement of the transponders, reliably reading out the transponder data is impossible due to the obvious influence of the barrel collar to the electromagnetic field.

### SUMMARY OF THE INVENTION

The present invention is based on the object of proposing a transponder device or a transponder system of the transponder device which, when arranged on a metallic surface, enables the transponder data to be read out with sufficient reliability.

To achieve this object, the device according to the invention has the features of claim 1.

According to the invention, at least the outer antenna portion of the antenna is arranged at an angle α1 relative to the mounting substrate.

The invention is based on the knowledge that when the antenna is arranged on the metallic surface of the barrel, absolutely desired but also parasitic capacitances are formed due to a capacitive coupling, in particular between the inner antenna area facing the metallic surface of the barrel and the barrel surface. This applies all the more when the antenna is arranged on the angled metallic surfaces of the barrel collar, so that the resonance frequency of the antenna can be detuned due to the parasitic capacitances.

In contrast to an arrangement of the transponder on the curved bottom of the bladder of the metal barrel, i.e. in an area of the electromagnetic field that is largely unaffected by the barrel collar, the parasitic capacitances in the area of the barrel collar, which also causes interference in the electromagnetic field, have a much stronger effect to the resonance frequency, so that as a result of this there is an insufficient energy supply to the transponder via the electromagnetic field and thus the reading of the transponder is impaired.

As already emphasized, due to an inclined position of the outer antenna portion with respect to the mounting substrate, i.e. by adjusting an angle between the outer antenna portion and the mounting substrate, it is possible to offset parasitic capacitance caused by capacitive coupling between the inner antenna portion and the metallic surface of the barrel and thus a shift of the resonance point of the antenna can be reached. In addition, it has been proved that the radiation behavior of the antenna can also be positively influenced by adjusting the angle between the outer antenna area and the mounting substrate.

In the case of the transponder device according to the invention, the parasitic influences are counteracted by adapting a mechanical adjusting parameter.

An adjusting device is preferably provided for the defined adjustment of the angle, so that in particular by exchanging the adjusting device, different angles, i.e. relative inclined positions of the outer antenna area with respect to the mounting substrate, can be adjusted.

It is particularly preferred that the adjusting device is formed by an adjusting body arranged between the antenna carrier and the mounting substrate, which in a possible embodiment is formed in one piece at the antenna carrier so that the angle can be changed, for example, by exchanging the adjusting body.

The adjusting body is preferably designed as a component that is formed independently of the antenna carrier, so that one and the same antenna carrier is retained independent of the desired angle and the adjusting of an angle can be reached by exchanging the adjusting body. It is particularly preferred that the adjusting body is designed to be alterable, for example by the way that the adjusting body is provided with a mechanical adjusting device, such as in particular an adjusting screw.

In a preferred embodiment of the transponder device, at least one subsection of the inner antenna portion is arranged adjacent to the mounting substrate as a coupling section for a capacitive coupling with a metallic support surface.

If at least one subsection of the inner antenna area is arranged at an angle α2 relative to the mounting substrate, a targeted influence on the parasitic capacitance formed between a metallic support surface and the transponder device is possible.

Preferably, the angle α2 is equal to the angle α1, so that in a particularly simple embodiment of the transponder device, the antenna carrier is provided with two parallel surfaces for a correspondingly parallel arrangement of the outer antenna area and the inner antenna area, and only the wedge-shaped adjusting body is required for adjusting the angle.

If the inner antenna area has two subsections which are arranged on two opposite surfaces of the adjusting body, the adjusting body can simultaneously form a part of the antenna carrier.

The mounting substrate preferably at least partially forms a housing underside of a housing for receiving the antenna carrier provided with the antenna arrangement and the adjusting body, so that a particularly compact and at the same time against external mechanical influences protected design of the transponder device is possible.

The transponder system according to the invention has a transponder device according to the invention, wherein the mounting substrate is arranged on a metallic surface formed by an inside of a barrel collar of a steel barrel.

The mounting substrate is preferably arranged in such a way that a surface of the antenna carrier provided with the outer antenna area is arranged at an angle α3 relative to the inside of the barrel collar.

The angle α3 is preferably equal to the angle α1, so that the mounting substrate is in a substantially parallel arrangement with respect to the inside of the barrel collar.

It is particularly preferred that the angle α1 is formed in a vertical plane running through the steel barrel, in such a way that the surface of the antenna carrier is arranged rising from a collar edge to a barrel bladder. This not only makes it possible to compensate for a parasitic capacitance caused by the barrel collar, but in addition, despite the arrangement of the antenna carrier on the barrel collar, an orientation of the antenna that is advantageous for effective coupling of the antenna to a reader is obtained.

An advantageous compensation of parasitic capacitances can already be achieved if the angle α1 is formed in a vertical plane running through the steel barrel, in such a way that the surface of the antenna carrier is arranged sloping down from a collar edge to a barrel bladder.

### DESCRIPTION OF THE DRAWINGS

In the following, advantageous embodiments of the present invention are explained in detail with reference to the drawings. In the drawings:

FIG.1 shows a first embodiment of a transponder device;

FIG. 2 shows a second embodiment of a transponder device;

FIG. 3 shows a transponder system with a transponder device of a third embodiment provided on the inside of the barrel collar;

FIG. 4 shows the transponder system corresponding to FIG. 3, which has a transponder device of a fourth embodiment;

FIG. 5 shows the transponder system corresponding to FIG. 3, which has a transponder device of a fifth embodiment;

FIG. 6 shows the transponder system corresponding to FIG. 3, which has a transponder device of the fifth embodiment;

FIG. 7 shows the transponder system corresponding to FIG. 3, which has a transponder device of the fifth embodiment.

### PREFERRED EMBODIMENTS OF THE INVENTION

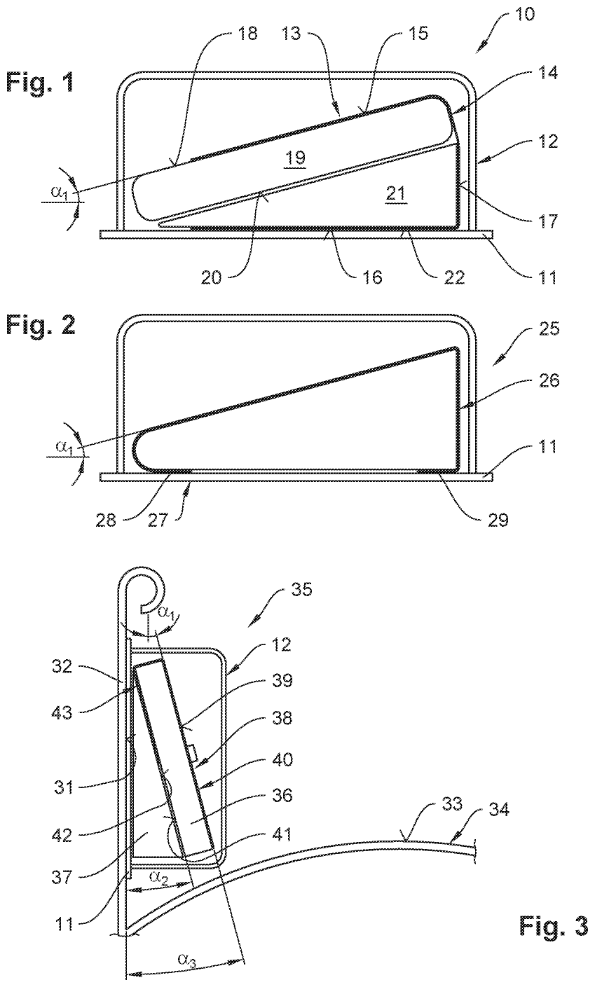

FIG.1 shows a transponder device 10 with a mounting substrate 11, which is used to fasten the transponder device 10 on an essentially metallic surface, wherein the metallic surface can also be provided with a dielectric coating

In this case, the mounting substrate 11 simultaneously forms the bottom of a housing 12, which is used to accommodate an RFID transponder 13, which has a chip (not shown here) in contact with a UHF antenna arrangement 14, preferably designed as a film antenna. The antenna arrangement 14 has an outer antenna area 15 which is connected to an inner antenna area 16 via a connecting section 17. The outer antenna area 15 is arranged on an outer surface 18 of an antenna carrier 19, which is arranged with an inner surface 20 parallel to the outer surface 18 on a wedge-shaped adjusting body 21. The inner antenna area 16 is arranged on an inner surface 22 of the adjusting body 21 facing the mounting substrate 11.

Although the adjusting body 21 is designed independently of the antenna carrier 19 in this case, in the illustrated embodiment the adjusting body 21 also takes on the function of an antenna carrier.

In contrast to the transponder device 10 shown in FIG. 1, in which the inner antenna area 16 extends continuously over the inner surface 22 of the adjusting body 22, FIG. 2 shows a transponder device 25 of the same design as the transponder device 10 except for a two-part inner antenna area 27 of an antenna arrangement 26 such that the antenna arrangement 26 is open to the mounting substrate 11 with two inner subsections 28, 29 of the antenna device 26, each of which allows a capacitive coupling of the antenna device 26 to a metallic support surface on which the mounting substrate 11 is arranged. As a further difference to the transponder device 10, the transponder device 25 has an antenna carrier 23 with an adjusting body formed in one piece with the antenna carrier 23 for adjusting the angle α1.

FIG. 3 shows a transponder system with a transponder device 35 arranged on an inside 31 of a metallic barrel collar 32 of a steel barrel (not shown below) above a curved bottom 33 of a bladder 34 of the steel barrel.

The transponder device 35, corresponding to the transponder device 10 shown in FIG. 1, has a housing 12 which accommodates an antenna carrier 36 and an adjusting body 37.

An antenna arrangement 38 is arranged on the antenna carrier 36, wherein the antenna arrangement comprises an outer antenna area 40 arranged on an outer surface 39 of the antenna carrier 36 and an inner antenna area 43 arranged between an inner surface 41 of the antenna carrier 36 and an outer surface 42 of the adjusting body 37.

The outer antenna area 40 of the antenna arrangement 38 is arranged at an angle α1 relative to the mounting substrate 11, which corresponds to the angle α3 between the outer antenna area 40 and the inside 31 of the barrel collar 32.

Furthermore, an angle α2 between the inner antenna area 43 and the mounting substrate 11 also corresponds to the angle α1.

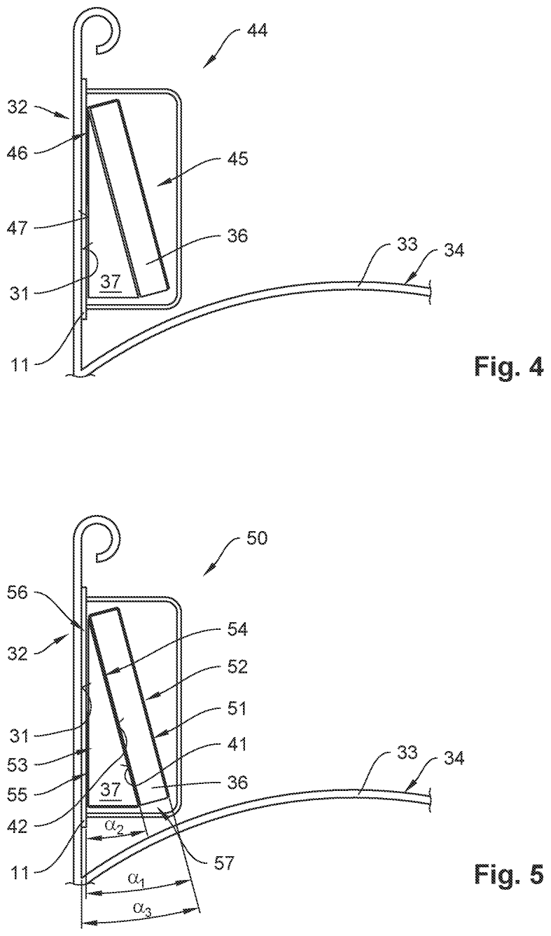

FIG. 4 shows a transponder system with a transponder device 44, which is arranged on the inner side 31 of the barrel collar 32 in accordance with the transponder device 35 and, like the transponder device 35 shown in FIG. 3, has an antenna carrier 36 and an adjusting body in a housing 12. The transponder device comprises an antenna arrangement 45 which, unlike the antenna device 38 shown in FIG. 3, has an inner antenna area 46, which is arranged between an inner surface 47 of the adjusting body 37 and the mounting substrate 11.

FIG. 5 shows a transponder device 50 which, in accordance with the transponder devices 35 and 44 shown in FIGS. 3 and 4, has an adjusting body 37 with an antenna carrier 36 arranged thereon, so that an outer antenna area 51 of an antenna arrangement 52 implemented in the transponder device 50 is also arranged at the angle α1 with respect to the mounting substrate 11 or at the angle α3 with respect to the inside 31 of the barrel collar.

In contrast to the antenna arrangements 38 and 45 of the transponder devices 35 and 44, however, an inner antenna area 53 of the antenna device 52 is arranged in such a way that it includes a subsection 54 arranged between the outer surface 42 of the adjusting body 37 and the inner surface 41 of the antenna carrier 36 as well includes a subsection 55 arranged between the inner surface 47 of the adjusting body 37 and the mounting substrate 11, so that only the subsection 54 of the inner antenna area 53 is arranged at an angle α2 with respect to the mounting substrate 11. In addition, the antenna arrangement 52 shown in FIG. 5 has a first antenna opening 56 formed at the adjusting body 37 between the subsections 54 and 55 and a second antenna opening 56 formed at the antenna carrier 36 between the outer antenna area 51 and the first subsection 54 of the inner antenna area 53.

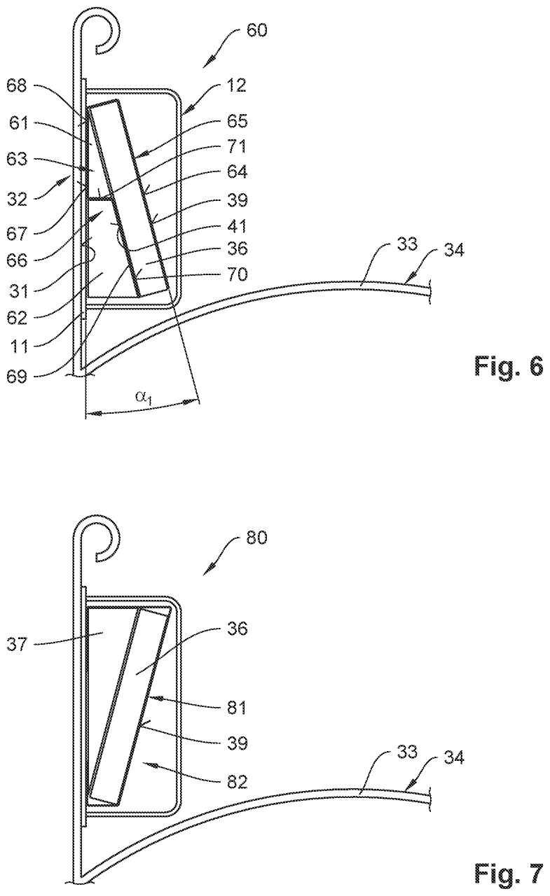

In a further embodiment, FIG. 6 shows a transponder device 60 which, in accordance with the transponder devices 35, 44 and 50 shown in FIGS. 3, 4 and 5, has an antenna carrier 36, wherein the transponder device 60 however has an adjusting body 63 formed with a first wedge portion 61 and a second wedge portion 62. Overall, due to the configuration of the adjusting body 63, an arrangement of an outer antenna area 64 of an antenna arrangement 65 is obtained, which corresponds to the arrangements of the outer antenna areas 40 and 51 of the transponder devices 35 and 50 with an angle α1 of the outer antenna area 64 with respect to the mounting substrate 11.

An inner antenna area 66 of the antenna arrangement 65 is arranged with a first subsection 67 between an inner surface 68 of the first wedge portion 61 and the mounting substrate 11. A second subsection 69 of the inner antenna area 66 is arranged between the inner surface 41 of the antenna carrier 36 and an outer surface 70 of the second wedge portion 62 of the adjusting body 63, wherein the first subsection 67 is connected to the second subsection 69 via an antenna shoulder 71 formed between the first and second wedge portions 61, 62

As FIG. 6 shows, the result of this is that only the second subsection 69 is arranged at an angle α2 with respect to the mounting substrate 11, and the antenna arrangement 65 shown in FIG. 6 only has an antenna opening 72 formed at the antenna carrier 36.

FIG. 7 shows in an embodiment a transponder device 80 with an adjusting body 37 rotated by 180° with respect to the transponder devices 35, 44, 50 and 60, in such a way that an outer antenna area 81 of an antenna arrangement 82 arranged on the outer surface 39 of the antenna carrier instead of sloping down from the bladder 34 with respect to the barrel collar 32, as in the case of the transponder systems shown in FIGS. 3 to 7, the outer antenna area 81 is arranged rising from the bladder 34 with respect to the barrel collar 32.

What is claimed is:

1. Transponder device (25, 35, 44, 50, 60, 80) with an antenna arrangement (14, 38, 45, 52, 65, 82) arranged on an antenna carrier (19, 36), in particular designed as a film antenna, wherein the transponder device comprises a mounting substrate (11) used to fasten on a metallic support surface, and the antenna arrangement comprises at least one inner antenna area (16, 43, 46, 66) arranged between the mounting substrate and the antenna carrier, and an outer antenna area (15, 40, 51, 64, 81) arranged on the antenna carrier opposite to the inner antenna area,
characterized in that,
at least the outer antenna area is arranged at an angle α1 relative to the mounting substrate.

2. Transponder device according to claim 1,
characterized by
an adjusting device for defined adjustment of the angle.

3. Transponder device according to claim 2,
characterized in that,
the adjusting device is formed by an adjusting body (21, 37) arranged between the antenna carrier (19, 36) and the mounting substrate (11).

4. Transponder device according to claim 3,
characterized in that,
the adjusting body is formed in one piece on the antenna carrier.

5. Transponder device according to claim 3,
characterized in that,
the adjusting body (21, 37) is designed as a component independent of the antenna carrier (19, 36).

6. Transponder device according to claim 2,
characterized in that,
the adjusting body is variable in order to change the angle.

7. Transponder device according to claim 1, characterized in that,
at least one subsection (55, 67) of the inner antenna area (53, 66) is arranged adjacent to the mounting substrate (11) as a coupling section for capacitive coupling with a metallic support surface.

8. Transponder device according to claim 1, characterized in that,
at least one subsection (54, 69) of the inner antenna area is arranged at an angle α2 relative to the mounting substrate (11).

9. Transponder device according to claim 8,
characterized in that,
the angle α2 is equal to the angle α1.

10. Transponder device according to claim 1, characterized in that,
the inner antenna area (53) has two subsections (54, 55), which are arranged on two mutually opposite surfaces (42, 47) of the adjusting body (37).

11. Transponder device according to claim 1, characterized in that,
the mounting substrate (11) at least partially forms a housing underside of a housing (12) for receiving the antenna carrier (19, 36) provided with the antenna arrangement and the adjusting body (21, 37).

12. Transponder system with a transponder device according to claim 1,
characterized in that,
the mounting substrate (11) is arranged on a metallic surface formed by an inner side (31) of a barrel collar (32) of a steel barrel.

13. Transponder system according to claim 12,
characterized in that,
the mounting substrate (11) is arranged such that a surface (39) of the antenna carrier (19, 36) provided with the outer antenna area (15, 40, 51, 64, 81) is arranged at an angle α3 relative to the inside (31) of the barrel collar (32).

14. Transponder system according to claim 13,
characterized in that,
the angle α3 is equal to the angle α1.

15. Transponder system according to claim 13,
characterized in that,
the angle α1 is formed in a vertical plane running through the steel barrel, in such a way that the outer surface (39) of the antenna carrier (36) is arranged rising from a collar edge of the barrel collar (32) to a barrel bladder (34).

16. Transponder system according to claim 13,
characterized in that,
the angle α1 is formed in a vertical plane running through the steel barrel, in such a way that the outer surface (39) of the antenna carrier (36) is arranged sloping down from a collar edge of the barrel collar (32) to a barrel bladder (34).
